(19) United States
(12) Patent Application Publication
(10) Pub. No.: US 2023/0352207 A1
(43) Pub. Date: Nov. 2, 2023

(54) WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kazunari SAKURA, Mie (JP); Shunji TOZAWA, Mie (JP)

(21) Appl. No.: 18/026,493

(22) PCT Filed: Aug. 5, 2021
(86) PCT No.: PCT/JP2021/029050

§ 371 Date: Mar. 15, 2023

(30) Foreign Application Priority Data
Sep. 29, 2020 (JP) 2020-163515

(51) Int. Cl. H01B 7/00; B60R 16/02

(52) U.S. Cl. CPC H01B 7/0045; B60R 16/0215

(57) ABSTRACT

One aspect of the present disclosure provides a wire harness that can improve assembly workability. A wire harness (10) according to one aspect of the present disclosure comprises an electric wire (20) and an exterior member (40) formed of a tape member (50). The tape member (50) is wound on the outer circumference of the electric wire (20) in a spiral shape so that the tape member (50) does not partially overlap in the thickness direction. The tape member (50) comprises: a base material (51) having a first surface (51A) and a second surface (51B); an adhesive section (52) provided on one end section among both the widthwise end sections of the first surface (51A) of the base material (51); and a noon-adhesive section (53) provided on the other end section among both the widthwise end sections of the first surface (51A) of the base material (51) The tape member (50) has the adhesive section (52) disposed at the starting end in the advancement direction (P1) when being mounted in a spiral shape.

### TECHNICAL FIELD

The present disclosure relates to a wire harness.

### BACKGROUND

Conventionally, in a wire harness that is routed inside a vehicle such as an automobile, an exterior member such as a corrugated tube is externally mounted to a wire bundle that is roughly wrapped with tape, thus suppressing the wire bundle from being damaged as a result of interfering with other members (e.g., see Patent Document 1).

In a wire harness of this type, the corrugated tube is provided with slits (split grooves) extending in the axial direction thereof, and therefore the corrugated tube can be easily attached to the wire bundle.

### PRIOR ART DOCUMENT

### Patent Document

Patent Document 1: JP H10-248137 A

### SUMMARY OF THE INVENTION

### Problem to be Solved

Meanwhile, since the corrugated tube serving as the exterior member is provided with slits, the conventional wire harness requires, for example, an operation of wrapping tape around the outer circumferential surface of the corrugated tube so as to prevent the wires from protruding from the slits and being damaged. Accordingly, there is still room for improvement in the workability of assembly of the wire harness.

An object of the present disclosure is to provide a wire harness for which the workability of assembly can be improved.

### Means to Solve the Problem

A wire harness according to the present disclosure includes: at least one wire; and an exterior member formed by a tape member, wherein the tape member is spirally wrapped around an outer circumferential surface of the wire such that portions in a width direction of the tape member overlap, the tape member includes a substrate having a first surface and a second surface opposite the first surface, an adhesive part provided at one of opposite end portions in a width direction of the first surface of the substrate, and a non-adhesive part provided at the other of the opposite end portions in the width direction of the first surface of the substrate, and the tape member includes the adhesive part disposed at a starting end in an advancing direction when being spirally wrapped.

### Effect of the Invention

With the wire harness according to the present disclosure, it is possible to achieve the effect of improving the workability of assembly.

### BRIEF DESCRIPTION OF THE DRAWINGS

FIG. 1 is a schematic configuration diagram showing a vehicle according to a first embodiment.

FIG. 2 is a schematic perspective view showing a wire harness according to the first embodiment.

FIG. 3 is a schematic cross-sectional view showing the wire harness according to the first embodiment.

FIG. 4 is a schematic perspective view showing a tape member according to the first embodiment.

FIG. 5 is a schematic transverse sectional view showing the tape member according to the first embodiment.

FIG. 6 is a schematic perspective view showing how the tape member according to the first embodiment is wrapped.

FIG. 7 is a schematic cross-sectional view showing a wire harness according to a second embodiment.

FIG. 8 is a schematic cross-sectional view showing the wire harness according to the second embodiment.

FIG. 9 is a schematic cross-sectional view showing the wire harness according to the second embodiment.

FIG. 10 is a schematic cross-sectional view showing a wire harness according to a modification.

FIG. 11 is a schematic transverse sectional view showing a tape member according to a modification.

FIG. 12 is a schematic plan view showing a tape member according to a modification.

FIG. 13 is a schematic plan view showing a tape member according to a modification.

FIG. 14 is a schematic cross-sectional view showing a wire harness according to a modification.

FIG. 15 is a schematic perspective view showing a tape member according to a modification.

FIG. 16 is a schematic plan view showing a tape member according to a modification.

FIG. 17 is a schematic plan view showing a tape member according to a modification.

FIG. 18 is a schematic plan view showing a tape member according to a modification.

FIG. 19 is a schematic plan view showing a tape member according to a modification.

FIG. 20 is a schematic transverse sectional view showing a tape member according to a modification.

FIG. 21 is a schematic transverse sectional view showing a tape member according to a modification.

### DETAILED DESCRIPTION TO EXECUTE THE INVENTION

### Description of Embodiments of the Present Disclosure

First, embodiments of the present disclosure will be listed and described.

A wire harness according to the present disclosure includes at least one wire; and an exterior member formed by a tape member, wherein the tape member is spirally wrapped around an outer circumferential surface of the wire such that portions in a width direction of the tape member overlap, the tape member includes a substrate having a first surface and a second surface opposite the first surface, an adhesive part provided at one of opposite end portions in a width direction of the first surface of the substrate, and a non-adhesive part provided at the other of the opposite end portions in the width direction of the first surface of the substrate, and the tape member includes the adhesive part disposed at a starting end in an advancing direction when being spirally wrapped.

With this configuration, the adhesive part is provided at one of the opposite end portions in the width direction of the first surface of the substrate, and the non-adhesive part is provided at the other end portion. In addition, the tape member is spirally wrapped around the outer circumferential surface of the wire such that portions in the width direction of the tape member overlap in a state in which the adhesive part is disposed at the starting end in the advancing direction of the tape member. Accordingly, when the tape member is spirally wrapped, the adhesive part of a portion of the tape member that is subsequently wrapped can be suitably overlapped with a portion of the tape member that has been previously wrapped. Thus, a portion in the width direction of the previously wrapped portion of the tape member and a portion in the width direction of the subsequently wrapped portion of the tape member are bonded to each other by the adhesive part of the subsequently wrapped portion of the tape member, thus forming a tube surrounding the outer circumferential surfaces of the wire. The wire can be protected by the tube formed by the tape member. Accordingly, a tubular exterior member that protects the outer circumferential surface of the wire can be formed by spirally wrapping the tape member around the outer circumferential surface of the wire. As a result, as compared with, for example, a case where a corrugated tube having slits is mounted to the outer circumferential surface of the wire, and thereafter tape is wrapped around the outer circumferential surface of the corrugated tube, it is possible to reduce the number of work processes, thus improving the workability of assembly.

The adhesive part and the non-adhesive part are provided on the first surface of the substrate, and the adhesive part is provided only in a portion in the width direction. Accordingly, when the tape member is spirally wrapped around the outer circumferential surface of the wire, the region in which the tape member is bonded to the outer circumferential surface of the wire can be reduced as compared with a case where the adhesive part is provided on the entire first surface of the substrate. This makes it possible to suppress an increase in the rigidity of the wire harness due to wrapping of the tape member.

It is preferable that the tape member is spirally wrapped around the outer circumferential surface of the wire such that the entire adhesive part of a portion of the tape member that is subsequently wrapped around the outer circumferential surface of the wire overlaps a portion of the tape member that has been previously wrapped around the outer circumferential surface of the wire. With this configuration, the entire adhesive part of the subsequently wrapped portion of the tape member is overlapped with the previously wrapped portion of the tape member. Accordingly, the adhesive part of the subsequently wrapped portion of the tape member is bonded only to the previously wrapped portion of the tape member, and is not bonded to the outer circumferential surface of the wire. Therefore, the tape member is not bonded to the outer circumferential surface of the wire at an intermediate portion in the length direction of the exterior member. This makes it possible to suitably suppress an increase in the rigidity of the wire harness due to wrapping of the tape member.

It is preferable that the tape member is spirally wrapped around the outer circumferential surface of the wire such that the adhesive part of a portion of the tape member that is subsequently wrapped around the outer circumferential surface of the wire does not overlap a portion at which the adhesive part is formed, of a portion in the width direction of the tape member that has been previously wrapped around the outer circumferential surface of the wire. With this configuration, it is possible to suitably suppress overlapping between the adhesive part of the previously wrapped portion of the tape member and the adhesive part of the subsequently wrapped portion of the tape member in the radial direction of the wire. Accordingly, it is possible to suppress the bonded portions from being formed in double layers in the radial direction of the wire. This makes it possible to suitably suppress an increase in the rigidity of the wire harness due to wrapping of the tape member.

The adhesive part may have a width that is smaller than a width of the non-adhesive part. With this configuration, the proportion of the non-adhesive part in the width direction of the first surface of the substrate is increased, and the proportion of the adhesive part in the width direction of the first surface of the substrate is reduced. Accordingly, it is possible to reduce the amount of the adhesive part per a predetermined length of the tape member. This makes it possible to reduce the weight of the tape member, thus reducing the weight of the exterior member.

The adhesive part may have a width that is larger than a width of the non-adhesive part. With this configuration, the proportion of the non-adhesive part in the width direction of the first surface of the substrate is reduced, and the proportion of the adhesive part in the width direction of the first surface of the substrate is increased. Thus, it is possible to increase the width of the overlap of the adhesive part of the subsequently wrapped portion of the tape member with the subsequently wrapped portion of the tape member, for example. Accordingly, it is possible to increase a double-layered portion formed as a result of portions of the tape member being bonded to each other by the adhesive part of the subsequently wrapped portion of the tape member, and increase the region in which the outer circumferential surface of the wire is protected by the double-layered tape member. As a result, it is possible to increase the protection performance of the exterior member.

It is preferable that the second surface of the substrate includes a mark indicating a formation region of the adhesive part. With this configuration, the formation region of the adhesive part can be recognized from the second surface side of the substrate by viewing the mark formed on the second surface, which is opposite the first surface on which the adhesive part is formed, of the substrate. Accordingly, when the tape member is wrapped around the outer circumferential surface of the wire group in a state in which the first surface of the substrate faces toward the outer circumferential surface of the wire group, it is possible to suitably adjust the overlap width of the tape member by viewing the mark on the second surface of the substrate that is located on the front surface side. For example, it is possible to suitably adjust the overlap width of the tape member such that the adhesive part of a portion of the tape member that is subsequently wrapped does not come into contact with the outer circumferential surface of the wire.

It is preferable that the adhesive part is a first adhesive part, and the tape member includes a second adhesive part provided at an intermediate portion in a width direction of the non-adhesive part. With this configuration, the second adhesive part can be bonded to the outer circumferential surface of the wire at the wrap finishing portion of the tape member, for example. This makes it possible to suppress the tape member from being curled up at the terminating end in the advancing direction of the tape member, or in other words, an end portion in the length direction of the exterior member.

It is preferable that the adhesive part is formed extending continuously or discontinuously in a length direction of the substrate. With this configuration, a portion of the tape member that has been previously wrapped and a portion of the tape member that is subsequently wrapped can be suitably bonded to each other by the adhesive part extending in the length direction of the substrate. This makes it possible to suitably maintain the tubular state of the exterior member.

It is preferable that the exterior member is a first exterior member, the wire harness further includes a second exterior member that surrounds an outer circumferential surface of the first exterior member, and the tape member is spirally wrapped around outer circumferential surfaces of a plurality of the wires inside the second exterior member. With this configuration, the tape member is spirally wrapped around the outer circumferential surfaces of the plurality of wires inside the second exterior member. The tape member binds together the plurality of wires. This makes it possible to suppress the plurality of wires from loosening inside the second exterior member. As a result, it is possible to suppress interference between the wires and the inner surface of the second exterior member due to loosening of the wires, and suppress damage of the second exterior member due to the interference.

It is preferable that the second exterior member includes: a first fixing part that is to be fixed to an opening-and-closing-body panel included in an opening and closing body of a vehicle; a second fixing part that is to be fixed to a body panel included in a body of the vehicle; and a coupling part that couples the first fixing part and the second fixing part, and the coupling part has a bellows structure. With this configuration, the opening-and-closing-body panel moves in a direction toward the body panel or a direction away from the body panel according to the opening/closing operation of the opening and closing body. The second exterior member is deformed so as to bend, and extend/contract according to the movement of the opening-and-closing-body panel. At this time, since the coupling part has a bellows structure having excellent flexibility, it is possible to suitably deform the second exterior member according to the movement of the opening-and-closing-body panel. Here, when the opening-and-closing-body panel moves in response to the opening/closing operation of the opening and closing body, the plurality of wires accommodated inside the second exterior member are deformed so as to bend, and extend/contract so as to follow deformation of the second exterior member. At this time, inside the second exterior member, the tape member including the adhesive part partially on the first surface of the substrate is spirally wrapped around the outer circumferential surfaces of the plurality of wires. Accordingly, it is possible to suppress an increase in the rigidity of the plurality of wires due to wrapping of the tape member as compared with a case where a tape member including the adhesive part on the entire first surface of the substrate is wrapped. Thus, the plurality of wires can be suitably deformed so as to follow deformation of the second exterior member. As a result, it is possible to suppress the plurality of wires from strongly interfering with the inner surface of the second exterior member, thus suitably suppressing the second exterior member from being damaged.

It is preferable that the wire harness further includes a friction coefficient reducing part provided between an outer surface of the first exterior member and an inner surface of the second exterior member. With this configuration, the provision of the friction coefficient reducing part can reduce the coefficient of friction between the first exterior member and the second exterior member. Accordingly, it is possible to suitably suppress the wearing out of the second exterior member due to contact with the first exterior member, thus suitably suppressing damage such as breakage of the second exterior member.

It is preferable that the friction coefficient reducing part is provided at a portion in a width direction of the second surface of the substrate, and the friction coefficient reducing part is provided at a portion that overlaps the adhesive part in a thickness direction of the substrate. With this configuration, the friction coefficient reducing part is provided at a portion in the width direction of the second surface of the substrate, and the friction coefficient reducing part is provided so as to overlap the adhesive part in the thickness direction of the substrate. Accordingly, when the tape member is spirally wrapped around the outer circumferential surfaces of the plurality of wires, it is possible to suppress the adhesive part of a portion of the tape member that is subsequently wrapped from overlapping the friction coefficient reducing part of a portion of the tape member that has been previously wrapped. This makes it possible to suppress the bonding performance of the adhesive part from being impaired by the friction coefficient reducing part. In other words, even if the friction coefficient reducing part is provided on the second surface of the tape member, a portion of the tape member that is subsequently wrapped can be suitably bonded to a portion of the tape member that has been previously wrapped by the adhesive part of the subsequently wrapped portion of the tape member.

### DETAILS OF EMBODIMENTS OF THE PRESENT DISCLOSURE

Specific examples of the wire harness according to the present disclosure will be described below with reference to the drawings. In the drawings, portions of configurations are shown exaggerated or simplified in some cases for convenience of description. In addition, dimensional proportions of the portions may be different from the actual dimensional proportions in the drawings. It should be noted that the present invention is not limited to these examples, and is intended to include all modifications which fall within the scope of the claims and the meaning and scope of equivalents thereof.

The term “tubular” as described herein includes not only a shape with a peripheral wall continuously formed over the entire circumference in a circumferential direction, but also a tubular shape formed by a combination of a plurality of components, and a tubular shape having a partially cut-out portion or the like in a circumferential direction thereof, such as a C-shape. The “tubular” shape includes a circular shape, an elliptic shape, and a polygonal shape having a pointed or round angle. The term “annular” as used in the description of the present specification may refer to any structure that forms a loop, or a continuous shape having no end portion, and a generally loop-shaped structure having a gap such as a C-shape. Note that the “annular” shape includes, but is not limited to, a circular shape, an elliptic shape, and a polygonal shape having a pointed or round angle.

### First Embodiment

A wire harness according to a first embodiment will be described below with reference to the drawings.

(Configuration of Vehicle 1)

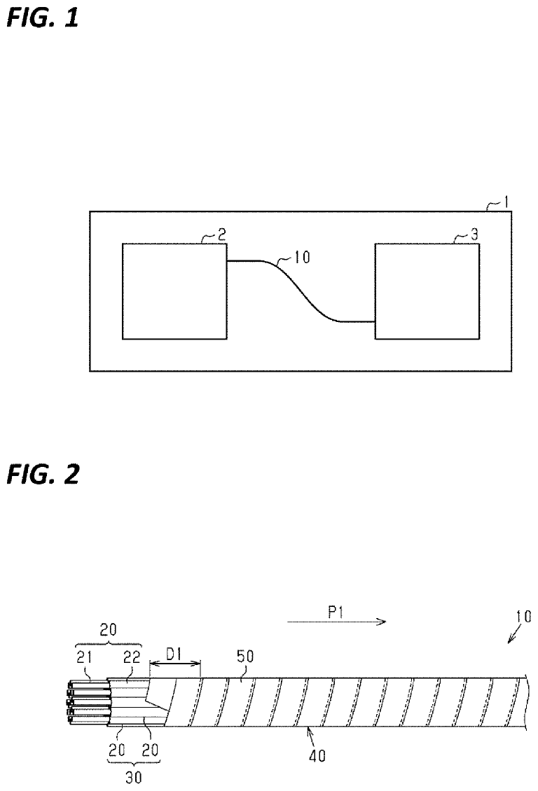

As shown in FIG. 1, a vehicle 1 includes a plurality of electric devices 2 and 3, and a wire harness 10 that electrically connects the plurality of electric devices 2 and 3. Examples of the electric devices 2 and 3 include a battery, an inverter, a motor, an air-conditioner device, a winker device, and an air-bag device.

(Configuration of Wire Harness 10)

As shown in FIG. 2, the wire harness 10 includes a wire group (wire bundle) 30 including a plurality of wires 20, and an exterior member 40 that surrounds the outer circumferential surface of the wire group 30. The wire group 30 (each wire 20) is formed in an elongated shape. The wire group 30 is formed to be two-dimensionally or three-dimensionally bendable according to the routing path of the wire harness 10, for example. Note that the wire group 30 may be branched midway in the longitudinal direction of the wire harness 10, for example.

(Configuration of Wire 20)

Each wire 20 is a covered wire including, for example, a core wire 21 made of a conductor, and an insulation covering 22 that covers the outer circumferential surface of the core wire 21. As the core wire 21, it is possible to use, for example, a stranded wire formed by twisting a plurality of metal strands together, a columnar conductor formed by a single columnar metal bar having a solid internal structure, a tubular conductor having a hollow internal structure, or the like. As the core wire 21, it is also possible to use, for example, a combination of a stranded wire, a columnar conductor, and a tubular conductor. Examples of the columnar conductor include a single-core wire and a bus bar. As the material of the core wire 21, it is possible to use a copper-based or aluminum-based metal material, for example.

The insulating covering 22 covers the entire outer circumferential surface of the core wire 21 in the circumferential direction, for example. For example, the insulating covering 22 is formed of an insulating material such as a synthetic resin. As the material of the insulating covering 22, it is possible to use, for example, a synthetic resin composed mainly of a polyolefin-based resin such as a crosslinked polyethylene or a cross-linked polypropylene. As the material of the insulating covering 22, it is possible to use one material alone, or two or more materials in an appropriate combination.

(Configuration of Exterior Member 40)

The exterior member 40 is formed so as to surround the entire outer circumferential surface of the wire group 30 in the circumferential direction. The exterior member 40 protects the wire group 30 from other members, flying objects, and water droplets, for example. For example, the exterior member 40 is provided at at least a portion in the longitudinal direction of the wire group 30 (each wire 20). The exterior member 40 is provided so as to cover the entire outer circumferential surface of the wire group 30 in the circumferential direction.

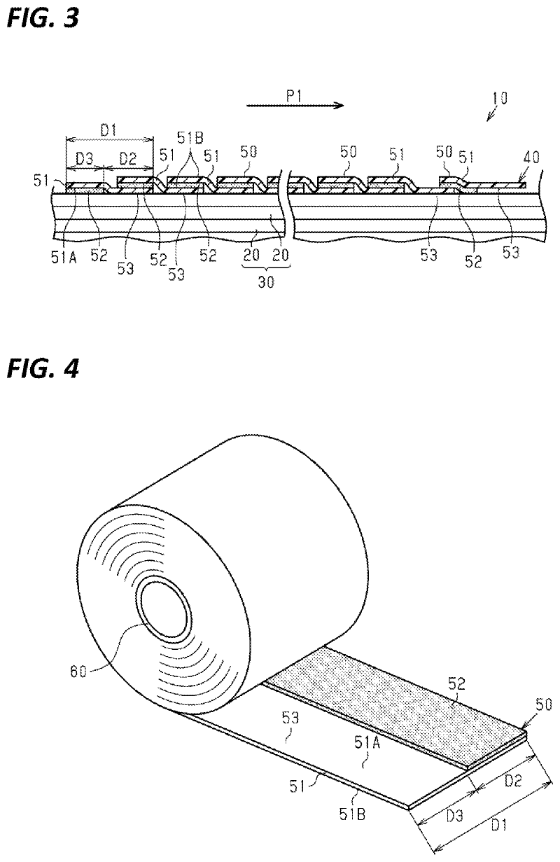

As shown in FIGS. 2 and 3, the exterior member 40 is formed, for example, by spirally wrapping one tape member 50. For example, the tape member 50 is spirally wrapped around the outer circumferential surface of the wire group 30 in the longitudinal direction of the wire group 30. The tape member 50 is spirally wrapped around the outer circumferential surface of the wire group 30 such that portions in the width direction of the tape member 50 overlap.

(Configuration of Tape Member 50)

Next, the tape member 50 before being wrapped around the outer circumferential surface of the wire group 30 will be described.

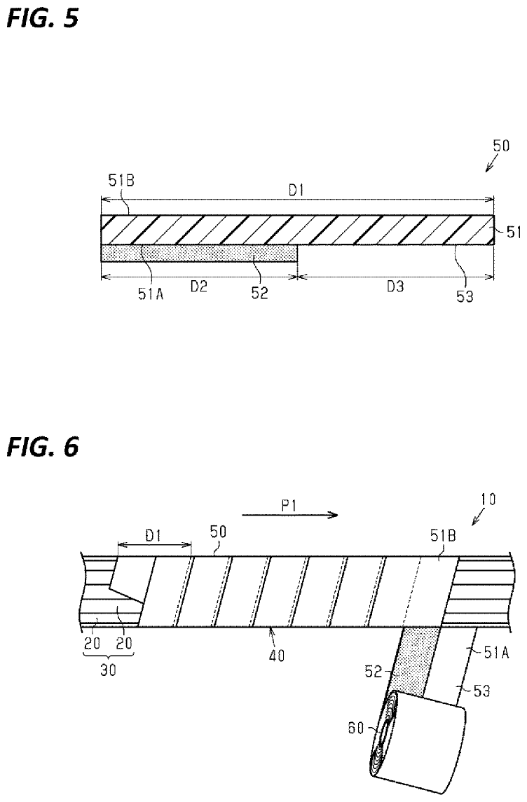

As shown in FIGS. 4 and 5, the tape member 50 includes a substrate 51. The substrate 51 has a first surface 51A and a second surface 51B. The substrate 51 is formed in an elongated band shape. The substrate 51 has a width D1 extending in a width direction (the lateral direction in FIG. 5) orthogonal to the length direction of the substrate 51. The width D1 of the substrate 51 may be about 25 mm to 100 mm, for example. The substrate 51 has a predetermined thickness extending in a thickness direction orthogonal to both the length direction and the width direction of the substrate 51. The thickness of the substrate 51 may be about 0.1 mm to 0.3 mm, for example. As the material of the substrate 51, it is possible to use a resin material or paper, for example. As the resin material, it is possible to use, for example, a polyolefin-based resin such as polyethylene or polypropylene, a polyamide resin such as nylon, or polyvinyl chloride.

The tape member 50 includes an adhesive part 52 formed on the first surface 51A of the substrate 51, and a non-adhesive part 53 formed on the first surface 51A of the substrate 51.

(Configuration of Adhesive Part 52)

The adhesive part 52 is provided at a portion in the width direction of the first surface 51A of the substrate 51. The adhesive part 52 of the present embodiment is provided at one of opposite end portions in the width direction of the first surface 51A. The adhesive part 52 has a width D2 extending in the width direction of the substrate 51. For example, the width D2 of the adhesive part 52 is about 20% to 80% of the width D1 of the substrate 51. The width D2 of the adhesive part 52 of the present embodiment is half the width D1 of the substrate 51. For example, the adhesive part 52 has a width D2 extending from one end portion in the width direction of the first surface 51A to the center in the width direction of the first surface 51A. For example, the adhesive part 52 is formed extending in the length direction of the substrate 51. For example, the adhesive part 52 extends continuously in the length direction of the substrate 51. The adhesive part 52 has a predetermined thickness. The thickness of the adhesive part 52 may be about 0.01 mm to 0.1 mm, for example. The adhesive part 52 is bonded to the first surface 51A of the substrate 51. For example, the adhesive part 52 is formed by applying an adhesive agent to the first surface 51A of the substrate 51. For the adhesive part 52, it is possible to use, for example, an acrylic resin-based adhesive agent or a butyl rubber-based adhesive agent.

(Configuration of Non-Adhesive Part 53)

The non-adhesive part 53 is provided at at least one of the opposite end portions in the width direction of the first surface 51A. The non-adhesive part 53 of the present embodiment is formed at an end portion at which the adhesive part 52 is not formed, of the opposite end portions in the width direction of the first surface 51A. That is, in the tape member 50 of the present embodiment, the adhesive part 52 is provided at one of the opposite end portions in the width direction of the first surface 51A, and the non-adhesive part 53 is provided on the other of the opposite end portions in the width direction of the first surface 51A. The non-adhesive part 53 has a width D3 extending in the width direction of the substrate 51. The width D3 of the non-adhesive part 53 is about 20% to 80% of the width D1 of the substrate 51, for example. The width D3 of the non-adhesive part 53 of the present embodiment is half the width D1 of the substrate 51. For example, the non-adhesive part 53 has a width D3 extending from one end portion in the width direction of the first surface 51A to the center in the width direction of the first surface 51A. That is, in the tape member 50 of the present embodiment, the adhesive part 52 is provided on half of the first surface 51A of the substrate 51 in the width direction, and the non-adhesive part 53 is provided on the remaining half thereof. For example, the non-adhesive part 53 is formed extending in the length direction of the substrate 51. For example, the non-adhesive part 53 extends continuously in the length direction of the substrate 51. The non-adhesive part 53 is formed, for example, by exposing the first surface 51A of the substrate 51 from the adhesive part 52, without forming the adhesive part 52 on the first surface 51A of the substrate 51. In the tape member 50 of the present embodiment, the adhesive part 52 and the non-adhesive part 53 are formed on the first surface 51A by forming a substrate 51, for example, by an extrusion molding process, and thereafter applying an adhesive agent only to a portion of the first surface 51A where the adhesive part 52 is to be formed, when applying the adhesive agent to the first surface 51A of the substrate 51 using a coating roller.

As shown in FIG. 4, for example, the tape member 50 is wrapped in layers around the outer circumferential surface of a core member 60 having a cylindrical shape such that the first surface 51A on which the adhesive part 52 is formed faces inward. Consequently, the tape member 50 is formed as a spiral (coli-shaped) structure along the outer circumferential surface of the core member 60. At this time, for example, the adhesive part 52 has an adhesive force that allows the adhesive part 52 to keep its shape after being wrapped around the outer circumferential surface of the core member 60, and that allows a layer of the substrate 51 to be separated from the inner layer of the substrate 51 and to be unwound when the adhesive part 52 is wrapped around the wire group 30 (see FIG. 2).

As shown in FIG. 6, when wrapping the tape member 50 around the outer circumferential surface of the wire group 30, the tape member 50 is drawn out from the spiral structure, and the tape member 50 that has been drawn out is spirally wrapped around the outer circumferential surface of the wire group 30. The tape member 50 is spirally wrapped around the outer circumferential surface of the wire group 30 in an advancing direction P1 (see the arrow in the drawing) extending in the longitudinal direction of the wire group 30. That is, the tape member 50 is spirally wrapped around the outer circumferential surface of the wire group 30 so as to advance from a starting end side (the left side in the drawing) in the advancing direction P1 toward a terminating end side (the right side in the drawing) in the advancing direction P1. At this time, the tape member 50 is wrapped around the outer circumferential surface of the wire group 30 in a state in which the first surface 51A on which the adhesive part 52 is formed faces toward the outer circumferential surface of the wire group 30, or in other words, in a state in which the first surface 51A faces radially inward of the wire group 30. Here, the tape member 50 is spirally wrapped around the outer circumferential surface of the plurality of wires 20 such that portions in the width direction of the tape member 50 overlap. That is, the tape member 50 has an overlap wrapping structure. Here, the overlap wrapping structure is a structure in which the tape member 50 is spirally wrapped such that predetermined portions in the width direction of the tape member 50 overlap each other. As the overlap wrapping structure, it is possible to adopt a half-lap wrapping structure, for example. Here, the half-lap wrapping structure is a structure in which the tape member 50 is spirally wrapped such that portions corresponding to substantially halves in the width direction of the tape member 50 overlap each other. The tape member 50 of the present embodiment has a half-lap wrapping structure. The half-lap wrapping structure of the tape member 50 will be described below.

As shown in FIG. 3, the tape member 50 of the present embodiment is wrapped such that half of a portion in the width direction of the tape member 50 that is subsequently wrapped overlaps half of the second surface 51B in the width direction of a portion of the tape member 50 that has been previously wrapped. Here, the tape member 50 is wrapped around the outer circumferential surface of the wire group 30 in a state in which the adhesive part 52 is located on the starting end side (the left side in the drawing) in the advancing direction P1 when the tape member 50 is spirally wrapped, and the non-adhesive part 53 is located on the terminating end side (the right side in the drawing) in the advancing direction P1, while the first surface 51A of the substrate 51 faces toward the outer circumferential surface of the wire group 30. More specifically, a wrap starting portion of the tape member 50, or in other words, the first turn of the tape member 50 that is first wrapped around the outer circumferential surface of the wire group 30 is wrapped around the outer circumferential surface of the wire group 30 such that the adhesive part 52 is located at the starting end (the left end in the drawing) in the advancing direction P1 in the width direction of the tape member 50. In other words, the first turn of the tape member 50 is wrapped around the outer circumferential surface of the wire group 30 in a state in which the non-adhesive part 53 is located on the terminating end side (the right side in the drawing) in the advancing direction P1 in the width direction of the tape member 50. At this time, only a portion of the first turn of the tape member 50 that has the adhesive part 52 is bonded to the outer circumferential surface of the wire group 30, and a portion thereof that has the non-adhesive part 53 is not bonded to the outer circumferential surface of the wire group 30. Here, the adhesive part 52 of the present embodiment has a width D2 that is half the width of the tape member 50 in the width direction. Accordingly, only half of the first turn in the width direction of the tape member 50 that is wrapped around the outer circumferential surface of the wire group 30 is bonded to the outer circumferential surface of the wire group 30.

A portion of the tape member 50 that is wrapped following the wrap starting portion of the tape member 50, or in other words, the second turn of the tape member 50 is wrapped such that its half in the width direction on the starting end side (the left side in the drawing) in the advancing direction P1 overlaps half of the first turn in the width direction of the tape member 50 on the terminating end side (the right side in the drawing) in the advancing direction P1. That is, the tape member 50 is wrapped such that the adhesive part 52 of the second turn of the tape member 50 overlaps the second surface 51B, which corresponds to the non-adhesive part 53, of the first turn of the tape member 50. In other words, the adhesive part 52 of the second turn of the tape member 50 overlaps the non-adhesive part 53 of the first turn of the tape member 50 in the radial direction of the wire group 30. In addition, the adhesive part 52 of the second turn of the tape member 50 is wrapped so as not to be in direct contact with the outer circumferential surface of the wire group 30, for example. That is, the adhesive part 52 of the second turn of the tape member 50 overlaps only the first turn of the tape member 50. In other words, the tape member 50 is spirally wrapped around the outer circumferential surface of the wire group 30 such that the entire adhesive part 52 of the second turn of the tape member 50 overlaps the first turn of the tape member 50. In addition, the adhesive part 52 of the second turn of the tape member 50 is wrapped so as not to overlap the adhesive part 52 of the first turn of the tape member 50 in the radial direction of the wire group 30. In other words, the adhesive part 52 of the second turn of the tape member 50 overlaps only the non-adhesive part 53 of a portion in the width direction of the first turn of the tape member 50 in the radial direction of the wire group 30. That is, the adhesive part 52 of the second turn of the tape member 50 is bonded to only the second surface 51B of a portion at which the non-adhesive part 53 is formed, of a portion in the width direction of the first turn of the tape member 50. On the other hand, the non-adhesive part 53 of the second turn of the tape member 50 is wrapped around the outer circumferential surface of the wire group 30. The non-adhesive part 53 of the second turn of the tape member 50 is wrapped so as not to overlap the first turn of the tape member 50, for example. In other words, the non-adhesive part 53 of the second turn of the tape member 50 is wrapped so as to cover only the outer circumferential surface of the wire group 30 that is exposed from the first turn of the tape member 50. However, the non-adhesive part 53 of the second turn of the tape member 50 is not bonded to the outer circumferential surface of the wire group 30. In this manner, the second turn of the tape member 50 is bonded only to the second surface 51B of the first turn of the tape member 50, and is not bonded to the outer circumferential surface of the wire group 30.

The second turn of the tape member 50 of the present embodiment is wrapped such that the entire adhesive part 52 of the second turn overlaps the second surface 51B of a portion at which the non-adhesive part 53 is formed, of a portion in the width direction of the previously wrapped first turn of the tape member 50. Similarly, the third and further turns of the tape member 50 are each wrapped such that the entire adhesive part 52 of a portion that is subsequently wrapped overlaps the second surface 51B of a portion at which the non-adhesive part 53 is formed, of a portion in the width direction of the previously wrapped portion of the tape member 50. Accordingly, as in the case of the second turn of the tape member 50, the third and further turns of the tape member 50 are each bonded only to the second surface 51B of the previously wrapped portion of the tape member 50, and are not bonded to the outer circumferential surface of the wire group 30. Here, as a result of the previously wrapped portion of the tape member 50 and the subsequently wrapped portion of the tape member 50 being bonded to each other by the adhesive part 52 of the subsequently wrapped portion of the tape member 50, the spirally wrapped tape member 50 is maintained in the tubular state. Thus, a tubular exterior member 40 that surrounds the outer circumferential surface of the wire group 30 is formed.

A wrap finishing portion of the tape member 50 is wrapped such that a portion of the adhesive part 52 is bonded to the outer circumferential surface of the wire group 30, for example. For example, the wrap finishing portion of the tape member 50 is wrapped such that a portion of the adhesive part 52 of the wrap finishing portion overlaps the previously wrapped portion of the tape member 50, and that the remaining portion of the adhesive part 52 of the wrap finishing portion is bonded to the outer circumferential surface of the wire group 30 that is exposed from the previously wrapped portion of the tape member 50. Accordingly, the wrap finishing portion of the tape member 50 can be bonded to the wire group 30, thus fixing the exterior member 40 to the wire group 30. Note that a fixing member may be provided that fixes the wrap finishing portion of the tape member 50, or in other words, an end portion in the length direction of the exterior member 40 to the outer circumferential surface of the wire group 30. Similarly, a fixing member may be provided that fixes the wrap starting portion of the tape member 50, or in other words, an end portion in the length direction of the exterior member 40 to the outer circumferential surface of the wire group 30. Examples of the fixing member include a tape member different from the tape member 50, and a cable tie.

The exterior member 40 formed by the tape member 50 described thus far covers the entire outer circumferential surface of the wire group 30 in the circumferential direction. However, the tape member 50 is not bonded to the outer circumferential surface of the wire group 30 at an intermediate portion in the length direction of the exterior member 40 of the present embodiment.

Next, operations and effects of the present embodiment will be described.

(1-1) The wire harness 10 includes at least one wire 20, and an exterior member 40 formed by a tape member 50. The tape member 50 is spirally wrapped around the outer circumferential surface of the wire 20 such that portions in the width direction of the tape member 50 overlap. The tape member 50 includes a substrate 51 having a first surface 51A and a second surface 51B, an adhesive part 52 provided at one of opposite end portions in the width direction of the first surface 51A of the substrate 51, and a non-adhesive part 53 provided at the other of the opposite end portions in the width direction of the first surface 51A of the substrate 51. The tape member 50 includes the adhesive part 52 disposed at a starting end in an advancing direction P1 when being spirally wrapped.

With this configuration, the adhesive part 52 is provided at one of the opposite end portions in the width direction of the first surface 51A of the substrate 51, and the non-adhesive part 53 is provided at the other end portion. In addition, the tape member 50 is spirally wrapped around the outer circumferential surface of the wire 20 such that portions in the width direction of the tape member 50 overlap in a state in which the adhesive part 52 is disposed at the starting end in the advancing direction P1 of the tape member 50. Accordingly, when the tape member 50 is spirally wrapped, the adhesive part 52 of a portion of the tape member 50 that is subsequently wrapped can be suitably overlapped with a portion of the tape member 50 that has been previously wrapped. Thus, a portion in the width direction of the previously wrapped portion of the tape member 50 and a portion in the width direction of the subsequently wrapped portion of the tape member 50 are bonded to each other by the adhesive part 52 of the subsequently wrapped portion of the tape member 50, thus forming a tube surrounding the outer circumferential surfaces of the wire 20. The wire 20 can be protected by the tube formed by the tape member 50. Accordingly, a tubular exterior member 40 that protects the outer circumferential surface of the wire 20 can be formed by spirally wrapping the tape member 50 around the outer circumferential surface of the wire 20. As a result, as compared with, for example, a case where a corrugated tube having slits is mounted to the outer circumferential surface of the wire 20, and thereafter tape is wrapped around the outer circumferential surface of the corrugated tube, it is possible to reduce the number of work processes, thus improving the workability of assembly. Since the exterior member 40 can be formed by spirally wrapping the tape member 50 around the outer circumferential surface of the wire 20, the exterior member 40 can be easily attached to the wire 20 even after a large component such as a connector has been attached to the wire 20.

(1-2) The adhesive part 52 and the non-adhesive part 53 are provided on the first surface 51A of the substrate 51, and the adhesive part 52 is provided only in a portion in the width direction. Accordingly, when the tape member 50 is spirally wrapped around the outer circumferential surface of the wire 20, the region in which the tape member 50 is bonded to the outer circumferential surface of the wire 20 can be reduced as compared with a case where the adhesive part 52 is provided on the entire first surface 51A of the substrate 51. This makes it possible to suppress an increase in the rigidity of the wire harness 10 due to wrapping of the tape member 50, and it is therefore possible to increase the flexibility of the wire harness 10.

(1-3) Since the adhesive part 52 is provided only at a portion in the width direction of the substrate 51, it is possible to reduce the weight of the tape member 50 as compared with a case where the adhesive part 52 is provided on the entire first surface 51A of the substrate 51, thus reducing the material cost of the tape member 50. This makes it possible to reduce the weight of the wire harness 10, thus reducing the manufacturing cost of the wire harness 10.

(1-4) Since the adhesive part 52 is disposed at the starting end in the advancing direction P1 of the tape member 50, the adhesive part 52 can be bonded to a target object (the wire 20 in the present embodiment). This makes it possible to suppress the tape member 50 from being curled up at the starting end in the advancing direction P1 of the tape member 50, or in other words, one end portion of the exterior member 40.

(1-5) A portion of the tape member 50 that has been previously wrapped and a portion of the tape member 50 that is subsequently wrapped are bonded to each other by the adhesive part 52 of the subsequently wrapped portion of the tape member 50. Accordingly, at the overlapping portion between the previously wrapped portion of the tape member 50 and the adhesive part 52 of the subsequently wrapped portion of the tape member 50, the tape member 50 can be made double-layered in a state in which these portions of the tape member 50 are bonded to each other. The double-layered tape member 50 can suitably protect the wire 20. For example, the double-layered tape member 50 can suppress another member from coming into contact with the wire 20, and it is therefore possible to suppress wearing out of the wire 20 as a result of being rubbed with another member, for example.

(1-6) Furthermore, it is possible to adjust the performance of the exterior member 40 in protecting the wire 20 by adjusting the thickness of the substrate 51 of the tape member 50.

(1-7) The tape member 50 is spirally wrapped around the outer circumferential surface of the wire 20 such that the entire adhesive part 52 of a portion of the tape member 50 that is subsequently wrapped around the outer circumferential surface of the wire 20 overlaps a portion of the tape member 50 that has been previously wrapped around the outer circumferential surface of the wire 20. With this configuration, the adhesive part 52 of the subsequently wrapped portion of the tape member 50 overlaps only the previously wrapped portion of the tape member 50. That is, the adhesive part 52 of the subsequently wrapped portion of the tape member 50 is bonded only to the previously wrapped portion of the tape member 50, and is therefore not bonded to the outer circumferential surface of the wire 20. Accordingly, the tape member 50 is not bonded to the outer circumferential surface of the wire 20 at an intermediate portion in the length direction of the exterior member 40. This makes it possible to suitably suppress an increase in the rigidity of the wire harness 10 due to wrapping of the tape member 50.

(1-8) The tape member 50 is spirally wrapped around the outer circumferential surface of the wire 20 such that the adhesive part 52 of the subsequently wrapped portion of the tape member 50 does not overlap a portion at which the adhesive part 52 is formed, of a portion in the width direction of the previously wrapped portion of the tape member 50. With this configuration, it is possible to suitably suppress overlapping between the adhesive part 52 of the previously wrapped portion of the tape member 50 and the adhesive part 52 of the subsequently wrapped portion of the tape member 50 in the radial direction of the wire 20. Accordingly, it is possible to suppress the bonded portions from being formed in double layers in the radial direction of the wire 20. This makes it possible to suitably suppress an increase in the rigidity of the wire harness 10 due to wrapping of the tape member 50.

### Second Embodiment

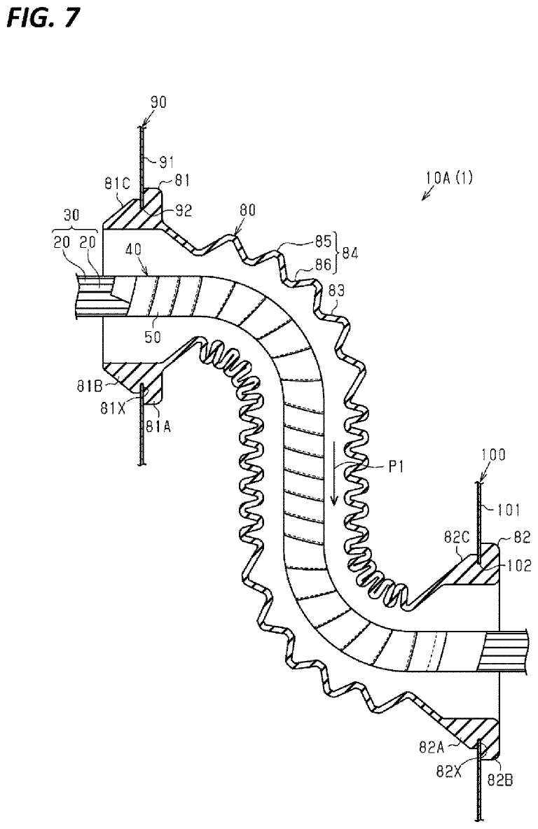

Next, a wire harness according to a second embodiment will be described with reference to FIGS. 7 to 9. Note that the description of the present embodiment is focused on the differences from the first embodiment, and therefore the same components as those of the first embodiment are denoted by the same reference numerals, and the descriptions thereof may be omitted partially or entirely.

(Configuration of Wire Harness 10A)

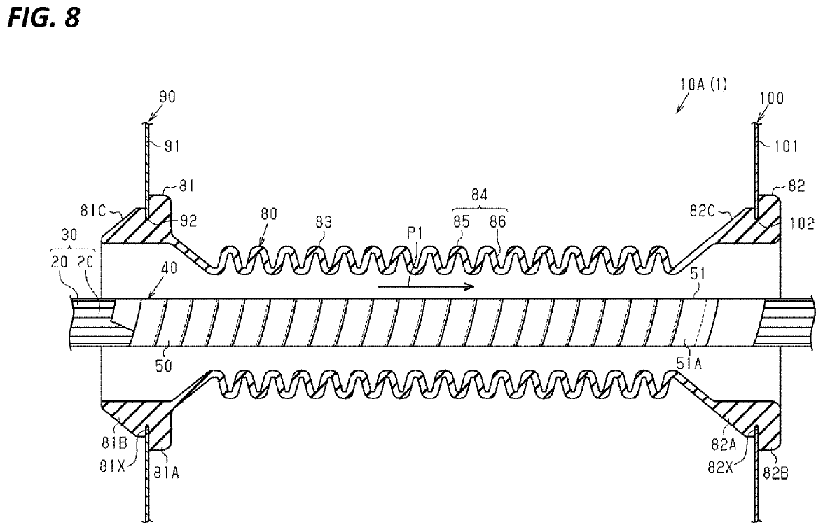

As shown in FIGS. 7 and 8, a wire harness 10A includes a wire group 30 including a plurality of wires 20, an exterior member 40 that surrounds the outer circumferential surface of the wire group 30, and a tubular exterior member 80 that surrounds the outer circumferential surface of the exterior member 40.

For example, the wire harness 10A is routed between an opening and closing body 90 of a vehicle 1 and a body 100 of the vehicle 1. Examples of the opening and closing body 90 include a door and a back door of the vehicle 1. The opening and closing body 90 includes an opening-and-closing-body panel 91 having a through hole 92. Examples of the opening-and-closing-body panel 91 include a door panel. The through hole 92 is formed extending through the opening-and-closing-body panel 91 in the thickness direction thereof, and is formed to allow the wire group 30 to pass therethrough. The body 100 includes a body panel 101 having a through hole 102. The body panel 101 is located between a waterproof region (e.g., the vehicle exterior) that requires waterproofing and a non-waterproof region (e.g., the vehicle interior) that does not require waterproofing, for example. That is, the body panel 101 is provided so as to separate between the waterproof region and the non-waterproof region. The through hole 102 is formed extending through the body panel 101 in the thickness direction thereof, and is formed to allow the wire group 30 to pass therethrough.

For example, the body panel 101 is a portion that is immobile relative to the body of the vehicle 1, whereas the opening-and-closing-body panel 91 is a portion that is movable in a direction toward the body panel 101 or a direction away from the body panel 101. In the present embodiment, a state in which the opening and closing body 90 (e.g., a door of the vehicle 1) is closed as a result of the opening-and-closing-body panel 91 moving closest to the body panel 101 is referred to as a closed state (see FIG. 7). A state in which the opening and closing body 90 is open as a result of the opening-and-closing-body panel 91 moving away from the body panel 101 is referred to as an open state (see FIG. 8). When the opening-and-closing-body panel 91 is opened/closed relative to the body panel 101, the wire harness 10A is deformed so as to bend, and extend/contract in response to the opening/closing operation.

(Configuration of Exterior Member 80)

The exterior member 80 is formed in a tubular shape that surrounds the entire outer circumferential surface of the exterior member 40, which surrounds the wire group 30, in the circumferential direction. The exterior member 80 is formed in an elongated tubular shape, for example. The exterior member 80 of the present embodiment is formed in a cylindrical shape. The exterior member 80 includes a fixing part 81 that is fixed to the opening-and-closing-body panel 91, a fixing part 82 that is fixed to the body panel 101, and a coupling part 83 that couples the fixing part 81 and the fixing part 82. The exterior member 80 is a single component obtained by continuously forming the fixing part 81, the coupling part 83, and the fixing part 82 into a single piece in the axial direction (length direction) of the exterior member 80. The axial direction of the exterior member 80 is a direction in which the central axis of the exterior member 80 extends. The fixing parts 81 and 82 are formed projecting radially outward of the exterior member 80 relative to the outer circumferential surface of the coupling part 83, for example. The fixing parts 81 and 82 are formed protruding radially outward of the outer circumferential surface of the coupling part 83 over the entire circumference of the coupling part 83 in the circumferential direction, for example. The outer diameters of the fixing parts 81 and 82 are formed to be larger than the outer diameter of the coupling part 83, for example.

As the material of the exterior member 80, it is possible to use, for example, an elastic material having a relatively high hardness. As the elastic material, it is possible to use, for example, a rubber such as EPDM (ethylene-propylene-diene rubber), or an elastomer. The exterior member 80 of the present embodiment is a grommet made of rubber. The exterior member 80 has the function of waterproofing the through hole 102 so as to prevent the entry of water from the waterproof region into the non-waterproof region, for example.

(Configuration of Fixing Part 81)

The fixing part 81 is to be fixed to the through hole 92 of the opening-and-closing-body panel 91. The fixing part 81 is fitted inside the through hole 92, for example. For example, the fixing part 81 is configured to elastically come into close contact with the opening-and-closing-body panel 91 while being fitted inside the through hole 92.

The fixing part 81 includes a groove 81X provided in the outer surface of the fixing part 81, a flange part 81A provided between the groove 81X and the coupling part 83, and a flange part 81B provided opposite to the flange part 81A in the axial direction of the fixing part 81. The groove 81X is formed in an annular shape centered around the central axis of the exterior member 80, for example. The groove 81X is formed continuously over the entire circumference of the fixing part 81 in the circumferential direction, for example. The outer diameter of the groove 81X is the same as the inner diameter of the through hole 92, for example. Here, the term “the same” as used herein includes, in addition to cases where subjects to be compared are completely the same, cases where subjects to be compared differ from each to a certain degree within the manufacturing tolerances or attachment tolerances.

The outer surface of the flange part 81B has an inclined surface 81C that is inclined such that the outer diameter thereof decreases from the groove 81X side as the distance from the groove 81X increases. The provision of the inclined surface 81C allows the fixing part 81 to be easily fitted to the through hole 92.

The opening-and-closing-body panel 91, which constitutes an edge portion of the through hole 92, is fitted to the groove 81X. At this time, the flange part 81A is in close contact with a surface of the opening-and-closing-body panel 91 that faces toward the body panel 101, and a surface of the opening-and-closing-body panel 91 that faces opposite to the body panel 101 is in close contact with the flange part 81B. Accordingly, the opening-and-closing-body panel 91 is elastically sandwiched between the flange part 81A and the flange part 81B. As a result, the fixing part 81 is fixed to the opening-and-closing-body panel 91.

(Configuration of Fixing Part 82)

The fixing part 82 is to be fixed to the through hole 102 of the body panel 101. The fixing part 82 is fitted inside the through hole 102, for example. For example, the fixing part 82 is configured to elastically come into close contact with the body panel 101 while being fitted inside the through hole 102.

The fixing part 82 includes a groove 82X provided in the outer surface of the fixing part 82, a flange part 82A provided between the groove 82X and the coupling part 83, and a flange part 82B provided opposite to the flange part 82A in the axial direction of the fixing part 82. The groove 82X is formed in an annular shape centered around the central axis of the exterior member 80, for example. The groove 82X is formed continuously over the entire circumference of the fixing part 82 in the circumferential direction, for example. The outer diameter of the groove 82X is the same as the inner diameter of the through hole 102, for example.

The outer surface of the flange part 82A has an inclined surface 82C that is inclined such that the outer diameter thereof decreases from the groove 82X side as the distance to the coupling part 83 decreases. The provision of the inclined surface 82C allows the through hole 102 to be easily fitted to the fixing part 82.

The body panel 101, which constitutes an edge portion of the through hole 102, is fitted to the groove 82X. At this time, the flange part 82A is in close contact with a surface of the body panel 101 that faces toward the opening-and-closing-body panel 91, and the flange part 82B is in close contact with a surface of the body panel 101 that faces opposite to the opening-and-closing-body panel 91. Accordingly, the body panel 101 is elastically sandwiched between the flange part 82A and the flange part 82B. As a result, the fixing part 82 is fixed to the body panel 101.

(Configuration of Coupling Part 83)

The coupling part 83 is provided between the fixing part 81 and the fixing part 82 in the axial direction of the exterior member 80. One end portion in the axial direction of the coupling part 83 is connected to the fixing part 81, and the other end portion in the axial direction of the coupling part 83 is connected to the fixing part 82. For example, the coupling part 83 has a bellows structure 84 in which annular protrusions 85 and annular recesses 86 are provided alternately and continuously in the axial direction of the coupling part 83. The bellows structure 84 is provided over the entire length of the coupling part 83 in the axial direction. Note that the bellows structure 84 may be provided only at a portion in the axial direction of the coupling part 83. The coupling part 83 is superior in flexibility to the wire group 30, for example. For example, the coupling part 83 is deformed so as to bend, and extend/contract according to the opening/closing operation of the opening-and-closing-body panel 91. As shown in FIG. 7, the coupling part 83 when the opening-and-closing-body panel 91 is in the closed state has a shape that is bent in a crank shape having two bent portions, for example. As shown in FIG. 8, the coupling part 83 when the opening-and-closing-body panel 91 is in the open state has, for example, a shape that extends straight between the opening-and-closing-body panel 91 and the body panel 101.

(Configuration of Wire Group 30)

The wire group 30 passes through the exterior member 80. A portion in the longitudinal direction of the wire group 30 is accommodated inside the exterior member 80 while the outer circumferential surface thereof is covered by the exterior member 40.

(Configuration of Exterior Member 40)

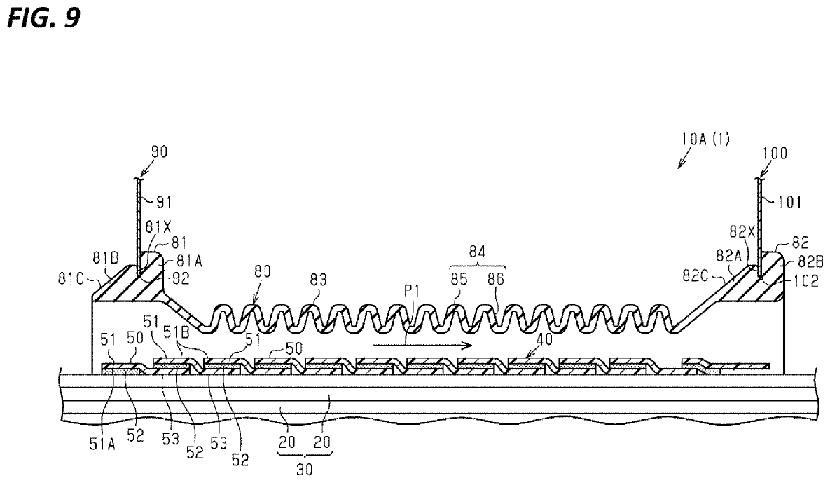

As shown in FIG. 9, the exterior member 40 is formed by spirally wrapping, around the outer circumferential surfaces of the plurality of wires 20, the tape member 50 including the adhesive part 52 and the non-adhesive part 53. The exterior member 40 is provided so as to surround the outer circumferential surface of a portion of the wire group 30 that is accommodated inside the exterior member 80. For example, the exterior member 40 is provided only inside the exterior member 80. For example, a starting end in the advancing direction P1 of the tape member 50 is provided inside the exterior member 80, and a terminating end in the advancing direction P1 of the tape member 50 is provided inside the exterior member 80. The tape member 50 includes the adhesive part 52 disposed at the starting end in the advancing direction P1 when being spirally wrapped. Also, at the starting end in the advancing direction P1, the adhesive part 52 is bonded to the outer circumferential surface of the wire group 30. The second and further turns of the tape member 50 are spirally wrapped such that the adhesive part 52 of a portion of the tape member 50 that is subsequently wrapped is overlapped with a portion of the tape member 50 that has been previously wrapped, for example. For example, the second and further turns of the tape member 50 are spirally wrapped such that the adhesive part 52 of the subsequently wrapped portion of the tape member 50 is not bonded to the outer circumferential surface of the wire group 30, or in other words, such that the adhesive part 52 is bonded only to the previously wrapped portion of the tape member 50.

Next, the operations of the wire harness 10A will be described.

When the opening and closing body 90 is opened/closed relative to the body 100, the opening-and-closing-body panel 91 moves in a direction toward the body panel 101, or a direction away from the body panel 101. The exterior member 80 is deformed according to this movement of the opening-and-closing-body panel 91. For example, as shown in FIG. 7, when the opening-and-closing-body panel 91 enters the closed state, the coupling part 83 of the exterior member 80 has a shape that is bent in a crank shape. For example, as shown in FIG. 8, when the opening-and-closing-body panel 91 enters the open state, the coupling part 83 of the exterior member 80 has a shape that extends straight. Accordingly, repeated opening/closing operations of the opening-and-closing-body panel 91 result in repeated deformation of the exterior member 80. Here, when the exterior member 80 is deformed in response to the opening/closing operation of the opening-and-closing-body panel 91, the wire group 30 accommodated inside the exterior member 80 is deformed so as to bend, or extend/stretch so as to follow the deformation of the exterior member 80. At this time, the tape member 50 is spirally wrapped around the outer circumferential surface of the wire group 30 inside the exterior member 80. The tape member 50 binds together the plurality of wires 20 constituting the wire group 30. This makes it possible to suppress the plurality of wires 20 from loosening inside the exterior member 80. In addition, it is possible to suppress the occurrence of an excess length of the wires 20 inside the exterior member 80, and suppress the occurrence of sagging of the wires 20 due to the excess length. As a result, it is possible to suppress the interference between the wires 20 and the inner surface of the exterior member 80 due to loosening or sagging of the wires 20, and suppress damage of the exterior member 80 due to such interference.

Meanwhile, the rigidity of the wire group 30 is increased when a tape member including the adhesive part 52 on the entire first surface 51A of the substrate 51 is spirally wrapped around the outer circumferential surface of the wire group 30. When the rigidity of the wire group 30 is increased, it is difficult to deform the exterior member 80 so as to follow deformation of the wire group 30. Then, a problem arises in that the exterior member 80 is damaged as a result of the wire group 30 strongly interfering with the inner surface of the exterior member 80.

In contrast, in the wire harness 10A, the tape member 50 including the adhesive part 52 partially on the first surface 51A of the substrate 51 is spirally wrapped around the outer circumferential surface of the wire group 30, thus suppressing an increase in the rigidity of the wire group 30 due to wrapping of the tape member 50. More specifically, the tape member 50 is spirally wrapped around the outer circumferential surfaces of the plurality of wires 20 such that portions in the width direction of the tape member 50 overlap, in a state in which the adhesive part 52 is disposed at the starting end in the advancing direction P1 of the tame member 50. Accordingly, when the tape member 50 is spirally wrapped, the adhesive part 52 of a portion of the tape member 50 that is subsequently wrapped can be suitably overlapped with a portion of the tape member 50 that has been previously wrapped. Thus, a portion in the width direction of the previously wrapped portion of the tape member 50 and a portion in the width direction of the subsequently wrapped portion of the tape member 50 are bonded to each other by the adhesive part 52 of the subsequently wrapped portion of the tape member 50, thus forming a tube surrounding the outer circumferential surfaces of the plurality of wires 20. For the tube formed by the tape member 50, a region in which the tape member 50 is bonded to the outer circumferential surfaces of the wires 20 can be reduced as compared with a case where the adhesive part 52 is provided on the entire first surface 51A of the substrate 51. This makes it possible to suppress an increase in the rigidity of the wire group 30 due to the wrapping of the tape member 50, and it is therefore possible to increase the flexibility of the wire group 30 as compared with a case where the adhesive part 52 is provided on the entire first surface 51A of the substrate 51. Accordingly, when the exterior member 80 is deformed according to the opening/closing operation of the opening-and-closing-body panel 91, the wire group 30 can be suitably deformed so as to follow the deformation of the exterior member 80. As a result, it is possible to suppress the wire group 30 from strongly interfering with the inner surface of the exterior member 80, thus suitably suppressing the exterior member 80 from being damaged.

In addition to the effects (1-1) to (1-8) of the first embodiment, the above-described embodiment can achieve the following effects.

(2-1) The tape member 50 is spirally wrapped around the outer circumferential surfaces of the plurality of wires 20 inside the exterior member 80. The tape member 50 binds together the plurality of wires 20. This makes it possible to suppress the plurality of wires 20 from loosening inside the exterior member 80. As a result, it is possible to suppress interference between the wires 20 and the inner surface of the exterior member 80 due to loosening of the wires 20, and suppress damage of the exterior member 80 due to the interference.

(2-2) The exterior member 80 is deformed so as to bend, and extend/contract according to movement of the opening-and-closing-body panel 91. At this time, inside the exterior member 80, the tape member 50 including the adhesive part 52 partially on the first surface 51A of the substrate 51 is spirally wrapped around the outer circumferential surfaces of the plurality of wires 20. Accordingly, it is possible to suppress an increase in the rigidity of the plurality of wires 20 due to wrapping of the tape member 50 as compared with a case where a tape member including the adhesive part 52 on the entire first surface 51A of the substrate 51 is wrapped. Thus, the plurality of wires 20 can be suitably deformed so as to follow deformation of the exterior member 80. As a result, it is possible to suppress the plurality of wires 20 from strongly interfering with the inner surface of the exterior member 80, thus suitably suppressing the exterior member 80 from being damaged.

### Modifications of Second Embodiment

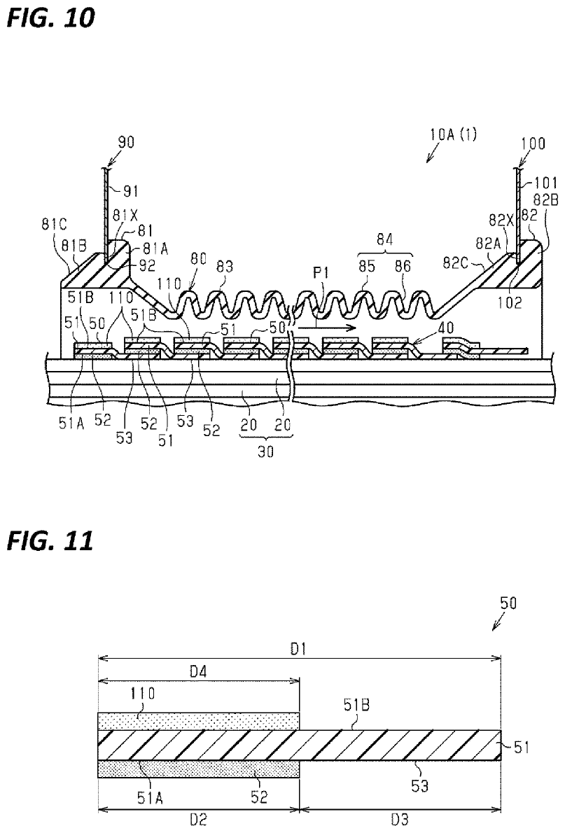

The second embodiment described above can be implemented in the following aspects in which the embodiment is changed as appropriate.
As shown in FIG. 10, a friction coefficient reducing part 110 may be provided between the outer surface of the exterior member 40 and the inner surface of the exterior member 80. As the material of the friction coefficient reducing part 110, it is possible to use a material capable of reducing the coefficient of friction between the exterior member 40 and the exterior member 80. For example, it is possible to use a lubricant as the friction coefficient reducing part 110. As the lubricant, it is possible to use a liquid lubricating oil, or grease or a solid lubricant, for example.

The friction coefficient reducing part 110 of the present modification is provided on the outer surface of the exterior member 40. For example, the friction coefficient reducing part 110 is provided on the second surface MB of the substrate 51 of the tape member 50. For example, the friction coefficient reducing part 110 is provided at a portion of the second surface 51B of the substrate 51 that is not covered by the adhesive part 52 of a portion of the tape member 50 that is subsequently wrapped, or in other words, a portion exposed from the adhesive part 52 of the subsequently wrapped portion of the tape member 50.

With this configuration, the provision of the friction coefficient reducing part 110 can reduce the coefficient of friction between the exterior member 40 and the exterior member 80. Accordingly, it is possible to suitably suppress the wearing out of the exterior member 80 due to contact with the exterior member 40, thus suitably suppressing damage such as breakage of the exterior member 80.
For example, as shown in FIG. 11, the friction coefficient reducing part 110 may be provided on the second surface 51B of the tape member 50 in a stage before the tape member 50 is spirally wrapped around the outer circumferential surfaces of the wires 20. The friction coefficient reducing part 110 is provided at a portion in the width direction of the second surface 51B of the substrate 51, for example. For example, the friction coefficient reducing part 110 is provided at one of opposite end portions in the width direction of the second surface 51B. For example, the friction coefficient reducing part 110 is provided so as to overlap the adhesive part 52 in the thickness direction of the substrate 51. For example, the friction coefficient reducing part 110 is provided so as not to overlap the non-adhesive part 53 in the thickness direction of the substrate 51. The friction coefficient reducing part 110 has a width D4 extending in the width direction of the substrate 51. For example, the width D4 of the friction coefficient reducing part 110 is about 20% to 80% of the width D1 of the substrate 51. The width D4 of the friction coefficient reducing part 110 of the present modification is half the width D1 of the substrate 51, and is the same as the width D2 of the adhesive part 52. For example, the friction coefficient reducing part 110 extends continuously in the length direction of the substrate 51. The friction coefficient reducing part 110 has a predetermined thickness. For example, the thickness of the friction coefficient reducing part 110 can be about 0.01 mm to 0.1 mm.

With this configuration, the friction coefficient reducing part 110 is provided at a portion in the width direction of the second surface 51B of the substrate 51, and the friction coefficient reducing part 110 is provided so as to overlap the adhesive part 52 in the thickness direction of the substrate 51. Accordingly, as shown in FIG. 10, when the tape member 50 is spirally wrapped around the outer circumferential surfaces of the wires 20, it is possible to suppress the adhesive part 52 of a portion of the tape member 50 that is subsequently wrapped from overlapping the friction coefficient reducing part 110 of a portion of the tape member 50 that has been previously wrapped. This makes it possible to suppress the bonding performance of the adhesive part 52 from being impaired by the friction coefficient reducing part 110. In other words, even if the friction coefficient reducing part 110 is provided on the second surface 51B of the tape member 50, a portion of the tape member 50 that is subsequently wrapped can be suitably bonded to a portion of the tape member 50 that has been previously wrapped by the adhesive part 52 of the subsequently wrapped portion of the tape member 50.
In the modification shown in FIG. 11, the width D4 of the friction coefficient reducing part 110 may be larger than the width D2 of the adhesive part 52, or may be smaller than the width D2 of the adhesive part 52.
In the modification shown in FIG. 11, the friction coefficient reducing part 110 may be provided so as to overlap the non-adhesive part 53 in the thickness direction of the substrate 51.
In the modification shown in FIG. 11, the friction coefficient reducing part 110 may be provided on the entire second surface 51B of the substrate 51.
In the modification shown in FIG. 10, after the tape member 50 has been spirally wrapped around the outer circumferential surfaces of the wires 20, the friction coefficient reducing part 110 may be provided, through application or the like, on the outer surface of the exterior member 40 formed by the tape member 50. In this case, the friction coefficient reducing part 110 may be provided so as to cover the entire outer surface of the exterior member 40, for example.
In the modification shown in FIG. 10, the friction coefficient reducing part 110 may be provided on the inner surface of the exterior member 80. In this case, the friction coefficient reducing part 110 provided on the outer surface of the exterior member 40 may be omitted.
The shape of the exterior member 80 of the above second embodiment is not particularly limited. For example, the bent shape or the like of the coupling part 83 is not particularly limited. For example, one of the fixing parts 81 and 82 may be omitted.
In the above second embodiment, the second exterior member that surrounds the outer circumferential surface of the exterior member 40 is implemented as the exterior member 80 provided between the opening-and-closing-body panel 91 and the body panel 101. However, the present disclosure is not limited thereto. The second exterior member may be implemented as an exterior member other than the exterior member 80, which repeatedly undergoes deformation such as bending and extension/contraction, including, for example, an exterior member that hardly undergoes deformation.

### Other Embodiments

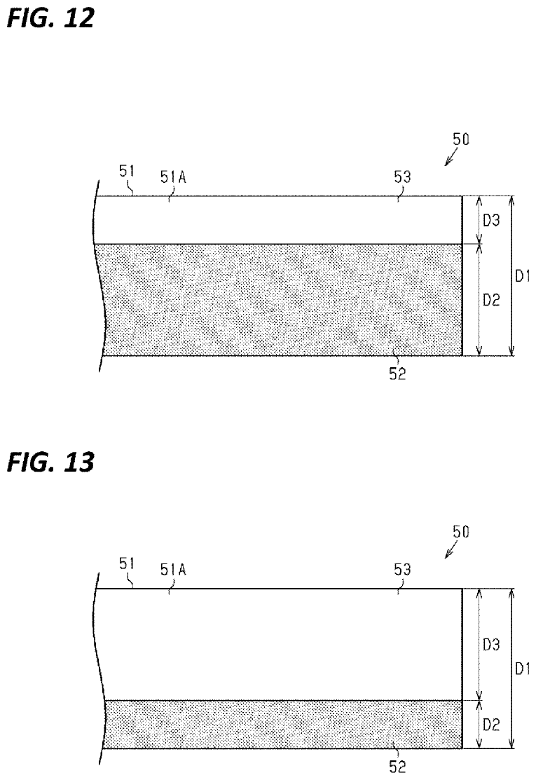

The above embodiments can be implemented with the following modifications. The above embodiments and the following modifications can be implemented in combination with each other as long as there are no technical discrepancies.
In the above embodiments, the width D2 of the adhesive part 52 is set to be a length equal to 50% of the width D1 of the substrate 51, and the width D3 of the non-adhesive part 53 is set to be a length equal to 50% of the width D1 of the substrate 51. However, the widths D2 and D3 are not limited thereto.
For example, as shown in FIG. 12, the width D2 of the adhesive part 52 may be formed to be larger than the width D3 of the non-adhesive part 53. For example, the width D2 of the adhesive part 52 may be set to a length equal to about 70% of the width D1 of the substrate 51, and the width D3 of the non-adhesive part 53 may be set to a length equal to about 30% of the width D1 of the substrate 51.

With this configuration, the proportion of the adhesive part 52 in the width direction of the first surface 51A of the substrate 51 is increased, and the proportion of the non-adhesive part 53 in the width direction of the first surface 51A of the substrate 51 is reduced. This makes it possible to increase the width of the overlap of the adhesive part 52 of the subsequently wrapped portion of the tape member 50 with the previously wrapped portion of the tape member 50, for example. Accordingly, it is possible to increase a double-layered portion formed as a result of portions of the tape member 50 being bonded to each other by the adhesive part 52 of the subsequently wrapped portion of the tape member 50, and increase the region in which the outer circumferential surface of the wire group 30 is protected by the double-layered tape member 50. As a result, it is possible to increase the protection performance of the exterior member 40. For example, it is possible to suitably suppress wearing out of the wires 20 as a result of being rubbed with another member, for example.
For example, as shown in FIG. 13, the width D2 of the adhesive part 52 may be formed to be smaller than the width D3 of the non-adhesive part 53. For example, the width D2 of the adhesive part 52 may be set to a length equal to about 30% of the width D1 of the substrate 51, and the width D3 of the non-adhesive part 53 may be set to a length equal to about 70% of the width D1 of the substrate 51.

With this configuration, the proportion of the non-adhesive part 53 in the width direction of the first surface 51A of the substrate 51 is increased, and the proportion of the adhesive part 52 in the width direction of the first surface 51A of the substrate 51 is reduced. Accordingly, it is possible to reduce the amount of the adhesive part 52 per a predetermined length of the tape member 50. This makes it possible to reduce the weight of the tape member 50, thus reducing the weight of the exterior member 40. In addition, it is possible to reduce the material cost of the tape member 50, thus reducing the manufacturing costs of the wire harnesses 10 and 10A.

In the above embodiments, the tape member 50 is spirally wrapped around the outer circumferential surface of the wire group 30 such that the adhesive part 52 of the previously wrapped portion of the tape member 50 and the adhesive part 52 of the subsequently wrapped portion of the tape member 50 do not overlap in the radial direction of the wire group 30. However, the present disclosure is not limited thereto. For example, the tape member 50 may be spirally wrapped around the outer circumferential surface of the wire group 30 such that a portion of the adhesive part 52 of the subsequently wrapped portion of the tape member 50 overlaps a portion at which the adhesive part 52 is formed, of a portion in the width direction of the previously wrapped portion of the tape member 50.
In the above embodiments, the tape member 50 is spirally wrapped around the outer circumferential surface of the wire group 30 such that the non-adhesive part 53 of the subsequently wrapped portion of the tape member 50 does not overlap the previously wrapped portion of the tape member 50. However, the present disclosure is not limited thereto.

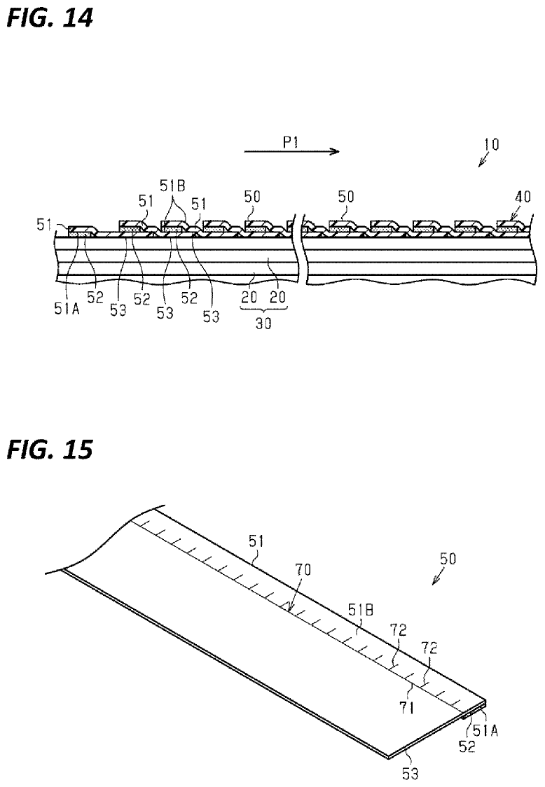

For example, as shown in FIG. 14, the tape member 50 may be spirally wrapped around the outer circumferential surface of the wire group 30 such that a portion of the non-adhesive part 53 of the subsequently wrapped portion of the tape member 50 overlaps the previously wrapped portion of the tape member 50. In this case, it is possible to increase the overlap width between the previously wrapped portion of the tape member 50 and the subsequently wrapped portion of the tape member 50, and it is thus possible to enhance the protection performance of the exterior member 40.

For example, as shown in FIG. 15, a mark 70 indicating a formation region of the adhesive part 52 formed on the first surface 51A of the substrate 51 may be formed on the second surface 51B of the substrate 51. For example, the mark 70 is formed so as to indicate the width of the adhesive part 52. For example, the mark 70 has a boundary line 71 indicating the boundary between the adhesive part 52 and the non-adhesive part 53. The boundary line 71 extends in the length direction of the substrate 51. For example, the mark 70 has auxiliary lines 72 extending from the boundary line 71 toward the formation region of the adhesive part 52 in the width direction of the substrate 51. For example, the mark 70 is formed in a color different from the color of the substrate 51.

With this configuration, the formation region of the adhesive part 52 can be recognized from the second surface 51B side of the substrate 51 by viewing the mark 70 formed on the second surface 51B of the substrate 51. Accordingly, when the tape member 50 is wrapped around the outer circumferential surface of the wire group 30 in a state in which the first surface 51A of the substrate 51 faces toward the outer circumferential surface of the wire group 30, it is possible to suitably adjust the overlap width of the tape member 50 by viewing the mark 70 on the second surface 51B of the substrate 51 that is located on the front surface side. For example, by wrapping the tape member 50 while viewing the mark 70, it is possible to suitably adjust the overlap width of the tape member 50 such that the entire adhesive part 52 of a portion of the tape member 50 that is subsequently wrapped overlaps a portion of the tape member 50 that has been previously wrapped. In other words, by wrapping the tape member 50 while viewing the mark 70, it is possible to suitably adjust the overlap width of the tape member 50 such that the adhesive parts 52 of the second and further turns of the tape member 50 do not come into contact with the outer circumferential surfaces of the wires 20.

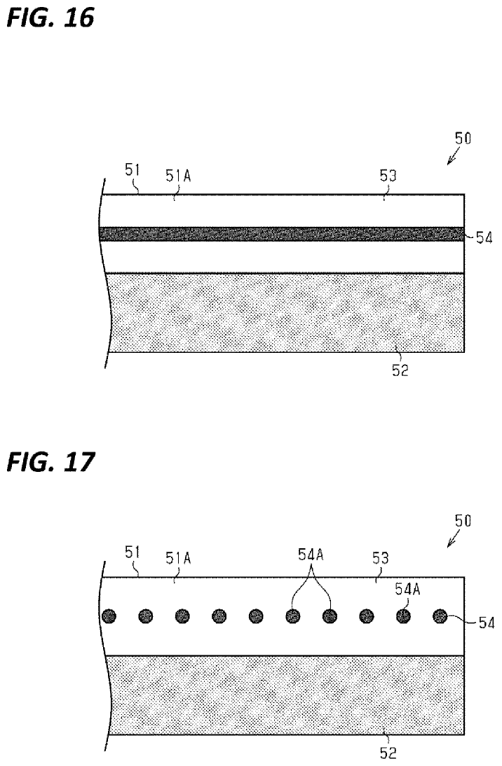

For example, as shown in FIG. 16, an adhesive part 54 (second adhesive part) that is different from the adhesive part 52 (first adhesive part) may be provided at a portion in the width direction of the non-adhesive part 53. The adhesive part 54 is provided at an intermediate portion in the width direction of the non-adhesive part 53. For example, the adhesive part 54 is provided at a central portion in the width direction of the non-adhesive part 53. The adhesive part 54 is provided on the first surface 51A of the substrate 51. For example, the adhesive part 54 is bonded to the first surface 51A of the substrate 51. The adhesive part 54 is formed, for example, by applying an adhesive agent to the first surface 51A of the substrate 51. For the adhesive part 54, it is possible to use an acrylic resin-based adhesive agent or a butyl rubber-based adhesive agent, for example.

The width of the adhesive part 54 is smaller than the width of the adhesive part 52, for example. For example, the adhesive part 54 is formed extending in the length direction of the substrate 51. For example, the adhesive part 54 extends continuously in the length direction of the substrate 51.

With this configuration, the adhesive part 54 can be bonded to the outer circumferential surfaces of the wires 20 at the wrap finishing portion of the tape member 50, for example. This makes it possible to suppress the tape member 50 from being curled up at the terminating end in the advancing direction P1 of the tape member 50, or in other words, an end portion in the length direction of the exterior member 40.
In the modification shown in FIG. 16, the adhesive part 54 is formed extending continuously in the length direction of the substrate 51. However, the present disclosure is not limited thereto.

For example, as shown in FIG. 17, the adhesive part 54 may be provided partially at predetermined intervals in the length direction of the substrate 51. That is, the adhesive part 54 may be provided extending discontinuously in the length direction of the substrate 51. The adhesive part 54 of the present modification includes a plurality of partial adhesive parts 54A. The plurality of partial adhesive parts 54A are spaced apart from each other in the length direction of the substrate 51. For example, the plurality of partial adhesive parts 54A are arranged in a row in the length direction of the substrate 51. The planar shape of each partial adhesive part 54A may be any shape. For example, the planar shape of each partial adhesive part 54A may be formed in a circular shape, an elliptic shape, or a polygonal shape. The planar shape of each partial adhesive part 54A of the present modification is formed in a circular shape.
In the above embodiments, the adhesive part 52 is formed extending continuously in the length direction of the substrate 51. However, the present disclosure is not limited thereto.

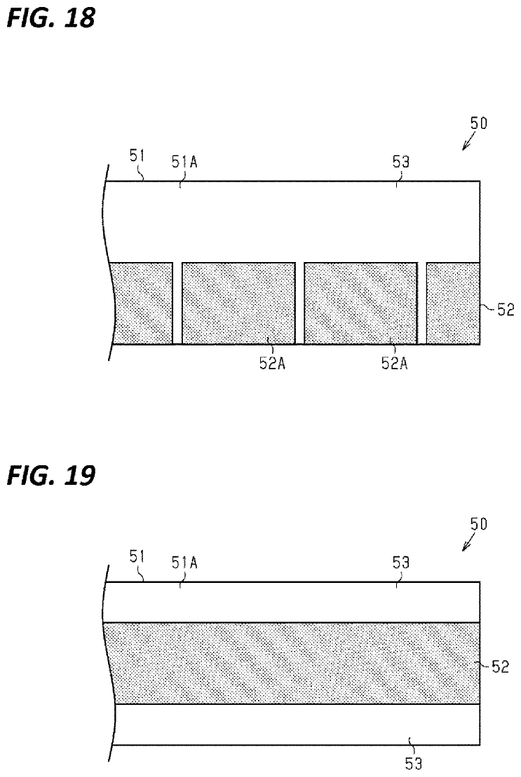

For example, as shown in FIG. 18, the adhesive part 52 may be provided partially at predetermined intervals in the length direction of the substrate 51. That is, the adhesive part 52 may be provided extending discontinuously in the length direction of the substrate 51. The adhesive part 52 of the present modification includes a plurality of partial adhesive parts 52A. The plurality of partial adhesive parts 52A are spaced apart from each other in the length direction of the substrate 51. For example, the plurality of partial adhesive parts 52A are arranged in a row in the length direction of the substrate 51. The planar shape of each partial adhesive part 52A may be any shape. For example, the planar shape of each partial adhesive part 52A may be formed in a circular shape, an elliptic shape, or a polygonal shape. The planar shape of each partial adhesive part 52A of the present modification is formed in a rectangular shape.
In the above embodiments, the adhesive part 52 is provided at one of opposite end portions in the width direction of the first surface 51A of the substrate 51, and the non-adhesive part 53 is provided at the other of the opposite end portions in the width direction of the first surface 51A of the substrate 51. However, the present disclosure is not limited thereto. The adhesive part 52 need only be provided at a portion in the width direction of the first surface 51A of the substrate 51, for example. The non-adhesive part 53 need only be provided at at least one of opposite end portions in the width direction of the first surface 51A of the substrate 51, for example.

For example, as shown in FIG. 19, the non-adhesive parts 53 may be provided at opposite end portions in the width direction of the first surface 51A of the substrate 51, and the adhesive part 52 may be provided at a central portion in the width direction of the first surface 51A of the substrate 51. That is, a pair of non-adhesive parts 53 may be provided on the first surface 51A of the substrate 51, and an adhesive part 52 may be provided between the pair of non-adhesive parts 53. The adhesive part 52 of the present modification is sandwiched between the pair of non-adhesive parts 53 in the width direction of the substrate 51.
In the above embodiments, the adhesive part 52 is provided on the first surface 51A of the substrate 51. However, the present disclosure is not limited thereto.

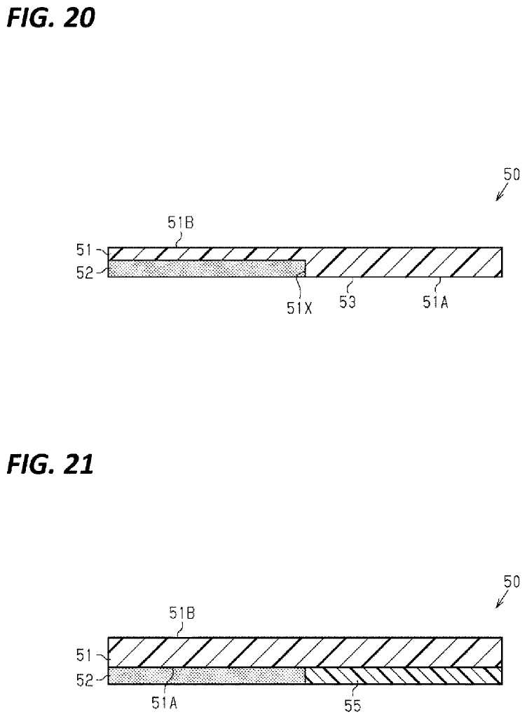

For example, as shown in FIG. 20, a recess 51X that is recessed toward the second surface 51B may be formed in the first surface 51A of the substrate 51, and the adhesive part 52 may be formed on a bottom surface of the recess 51X. At this time, the adhesive part 52 may be provided inside the recess 51X such that a first surface (the lower surface in the drawing) of the adhesive part 52 is flush with the first surface 51A of the substrate 51. With this configuration, it is possible to eliminate the level difference between the first surface 51A of the substrate 51 and the adhesive part 52.
In the above embodiments, the non-adhesive part 53 is formed by exposing the first surface 51A of the substrate 51 from the adhesive part 52, without forming the adhesive part 52 at a portion in the width direction of the first surface 51A of the substrate 51. However, the structure of the non-adhesive part 53 is not limited thereto.

For example, as shown in FIG. 21, a non-adhesive part 55 having a predetermined thickness may be formed on the first surface 51A of the substrate 51. As the material of the non-adhesive part 55, it is possible to use a resin material or paper, for example. As the resin material, it is possible to use, for example, a polyolefin-based resin such as polyethylene or polypropylene, a polyamide resin such as nylon, or polyvinyl chloride. The thickness of the non-adhesive part 55 is formed to be the same as the thickness of the adhesive part 52. For example, a first surface (the lower surface in the drawing) of the non-adhesive part 55 is formed to be flush with a first surface (the lower surface in the drawing) of the adhesive part 52.
In the above embodiments, the number of wires 20 constituting the wire group 30 is not particularly limited.
In the above first embodiment, the tape member 50 is wrapped around the outer circumferential surface of the wire group 30. However, the present disclosure is not limited thereto. For example, the tape member 50 may be wrapped around the outer circumferential surface of one wire 20. The exterior member 40 in this case is formed so as to surround the outer circumferential surface of the one wire 20.
In the above embodiments, the tape member 50 is wrapped around the outer circumferential surfaces of the wires 20. However, the present disclosure is not limited thereto. For example, the tape member 50 may be wrapped around the outer circumferential surface of a protective tube having the wires 20 accommodated therein, and the outer circumferential surfaces of the wires 20. For example, the starting end in the advancing direction P1 of the tape member 50 may be wrapped around the outer circumferential surface of the protective tube. In this case, the adhesive part 52 disposed at the starting end of in the advancing direction P1 the tape member 50 is bonded to the outer circumferential surface of the protective tube, for example. Note that as the protective tube, it is possible to use, for example, a pipe made of metal or resin, a protector made of resin, a flexible corrugated tube made of resin or the like, or a waterproofing cover made of rubber.
As shown in FIGS. 4 and 5, the width D1 of the substrate 51 may be the full width of the tape member 50. The width D2 of the adhesive part 52 may be constant over the entire length of the tape member 50.
As shown in FIGS. 6 to 8, the tape member 50 may be spirally wrapped with a helical pitch. The helical pitch of the tape member 50 may be constant, or may differ between a plurality of length portions of the wire harness 10. For example, the helical pitch of the tape member 50 may be constant at a straight portion of the wire harness 10. For example, the helical pitch of the tape member 50 may differ between a straight portion of the wire harness 10 and a bent portion of the wire harness 10. For example, the helical pitch of the tape member 50 may vary according to the bent angle of a bent portion of the wire harness 10. In the examples shown in FIGS. 6 to 8, the helical pitch of the tape member 50 corresponds to the overlap width of the tape member 50.
It should be appreciated that the embodiments disclosed herein are to be construed in all respects as illustrative and not limiting. The scope of the present invention is defined by the claims, rather than the description of the embodiment above, and is intended to include all modifications which fall within the scope of the claims and the meaning and scope of equivalents thereof.

The above-described various embodiments can be summarized as follows.

### Appendix 1

A wire harness including:
at least one wire; and
a tape member wrapped around the wire,
wherein the tape member is spirally wrapped around an outer circumferential surface of the wire such that portions in a width direction of the tape member overlap, and
the tape member includes a substrate having a first surface and a second surface opposite the first surface, an adhesive part provided at a portion in a width direction of the first surface of the substrate, and a non-adhesive part provided at at least one of opposite end portions in the width direction of the first surface of the substrate.

### Appendix 2

The wire harness according to Appendix 1,
wherein the tape member includes the adhesive part at one of the opposite end portions in the width direction of the first surface, and includes the non-adhesive part at the other end portion.

### LIST OF REFERENCE NUMERALS

1 Vehicle
2, 3 Electric device
10, 10A Wire harness
20 Wire
21 Core wire
22 Insulation covering
30 Wire group
40 Exterior member (first exterior member)
50 Tape member
51 Substrate
51A First surface
51B Second surface
51X Recess
52 Adhesive part (first adhesive part)
52A Partial adhesive part
53 Non-adhesive part
54 Adhesive part (second adhesive part)
54A Partial adhesive part
55 Non-adhesive part
60 Core member
70 Mark
71 Boundary line
72 Auxiliary line
80 Exterior member (second exterior member)
81 Fixing part (first fixing part)
81A, 81B Flange part
81C Inclined surface
81X Groove
82 Fixing part (second fixing part)
82A, 82B Flange part
82C Inclined surface
82X Groove
83 Coupling part
84 Bellows structure
85 Annular protrusion
86 Annular recess
90 Opening and closing body
91 Opening-and-closing-body panel
92 Through hole
100 Body
101 Body panel
102 Through hole
110 Friction coefficient reducing part
D1, D2, D3, D4 Width
P1 Advancing direction

1. A wire harness comprising:
at least one wire; and
an exterior member formed by a tape member,
wherein the tape member is spirally wrapped around an outer circumferential surface of the wire such that portions in a width direction of the tape member overlap,
the tape member includes a substrate having a first surface and a second surface opposite the first surface, an adhesive part provided at one of opposite end portions in a width direction of the first surface of the substrate, and a non-adhesive part provided at the other of the opposite end portions in the width direction of the first surface of the substrate, and
the tape member includes the adhesive part disposed at a starting end in an advancing direction when being spirally wrapped.

2. The wire harness according to claim 1,
wherein the tape member is spirally wrapped around the outer circumferential surface of the wire such that the entire adhesive part of a portion of the tape member that is subsequently wrapped around the outer circumferential surface of the wire overlaps a portion of the tape member that has been previously wrapped around the outer circumferential surface of the wire.

3. The wire harness according to claim 1,
wherein the tape member is spirally wrapped around the outer circumferential surface of the wire such that the adhesive part of a portion of the tape member that is subsequently wrapped around the outer circumferential surface of the wire does not overlap a portion at which the adhesive part is formed, of a portion in the width direction of the tape member that has been previously wrapped around the outer circumferential surface of the wire.

4. The wire harness according to claim 1,
wherein the adhesive part has a width that is smaller than a width of the non-adhesive part.

5. The wire harness according to claim 1,
wherein the adhesive part has a width that is larger than a width of the non-adhesive part.

6. The wire harness according to claim 1,
wherein the second surface of the substrate includes a mark indicating a formation region of the adhesive part.

7. The wire harness according to claim 1,
wherein the adhesive part is a first adhesive part, and
the tape member includes a second adhesive part provided at an intermediate portion in a width direction of the non-adhesive part.

8. The wire harness according to claim 1,
wherein the adhesive part is formed extending continuously or discontinuously in a length direction of the substrate.

9. The wire harness according to claim 1,
wherein the exterior member is a first exterior member,
the wire harness further comprises a second exterior member that surrounds an outer circumferential surface of the first exterior member, and
the tape member is spirally wrapped around outer circumferential surfaces of a plurality of the wires inside the second exterior member.

10. The wire harness according to claim 9,
wherein the second exterior member includes:
a first fixing part that is to be fixed to an opening-and-closing-body panel included in an opening and closing body of a vehicle;
a second fixing part that is to be fixed to a body panel included in a body of the vehicle; and
a coupling part that couples the first fixing part and the second fixing part, and
the coupling part has a bellows structure.

11. The wire harness according to claim 9, further comprising
a friction coefficient reducing part provided between an outer surface of the first exterior member and an inner surface of the second exterior member.

12. The wire harness according to claim 11,
wherein the friction coefficient reducing part is provided at a portion in a width direction of the second surface of the substrate, and
the friction coefficient reducing part is provided at a portion that overlaps the adhesive part in a thickness direction of the substrate.
